(19) United States
(12) Patent Application Publication
(10) Pub. No.: US 2020/0081231 A1
(43) Pub. Date: Mar. 12, 2020

(54) WIDE ANGLE LENS

(71) Applicant: NIDEC SANKYO CORPORATION, Nagano (JP)

(72) Inventor: Tadashi KOMIYAMA, Nagano (JP)

(21) Appl. No.: 16/467,209

(22) PCT Filed: Dec. 12, 2017
(86) PCT No.: PCT/JP2017/044492

§ 371 Date: Jun. 6, 2019

(30) Foreign Application Priority Data
Dec. 15, 2016 (JP) 2016-243638

(51) Int. Cl. G02B 13/16; G02B 9/64; G02B 13/04; G02B 13/00

(52) U.S. Cl. CPC G02B 13/16; G02B 9/64; H04N 5/74; G02B 13/006; G02B 13/04

(57) ABSTRACT

A wide angle lens may include first through seventh lenses and an aperture between the fourth and fifth lenses. The first and second lenses may be negative meniscus lenses. The third and sixth lenses may be negative lenses. The fourth and fifth lenses may be positive lenses. The first lens may have a convex surface facing the object side. The second and sixth lenses may each have a concave surface facing the image side. The third lens may have a concave surface facing the object side. The fourth lens may have a convex surface facing the image side. The seventh lens may be a biconvex lens having convex surfaces facing the object and image sides. The third, fourth lens, sixth lens, and seventh lenses may be plastic lenses. The third and fourth lenses may constitute a first cemented lens. The sixth and seventh lenses may constitute a second cemented lens.

### CROSS REFERENCE TO RELATED APPLICATIONS

This is the U.S. national stage of application No. PCT/JP2017/044492, filed on Dec. 12, 2017. Priority under 35 U.S.C. § 119(a) and 35 U.S.C. § 365(b) is claimed from Japanese Application No. 2016-243638, filed Dec. 15, 2016; the disclosures of which are incorporated herein by reference.

### TECHNICAL FIELD

At least an embodiment of the present invention relates to a wide angle lens used for various imaging systems.

### BACKGROUND

As for wide angle lenses, there has been proposed a wide angle lens of five pieces in four groups or six pieces in five groups in which a cemented lens is disposed on the image side with respect to an aperture so as to obtain a high resolution (see Patent Literature 1 and Patent Literature 2). However, just arranging a cemented lens on the image side with respect to the aperture does not sufficiently correct astigmatism and chromatic aberrations of magnification at a peripheral part. Furthermore, there has been proposed a wide angle lens of seven pieces in six groups in which four single lenses are disposed on the object side with respect to the aperture and a single positive lens and a cemented lens are disposed on the image side with respect to the aperture (see Patent Literature 3).

### PATENT LITERATURE

[Patent Literature 1] Japanese Patent Application Publication No. 2009-063877
[Patent Literature 2] Japanese Patent Application Publication No. 2015-034922
[Patent Literature 3] Japanese Patent Application Publication No. 2011-107425

For wide angle lenses, there has been an increasing demand for optical performance to achieve a higher resolution. Therefore, the wide angle lenses described in Patent Literature 1, Patent Literature 2, and Patent Literature 3 have a problem in that, when the positional relationship between lenses having high sensitivity is shifted, the resolution is degraded.

### SUMMARY

In view of the above problem, at least an embodiment of the present invention provides a wide angle lens that is capable of achieving a higher resolution.

In order to solve the above problem, the wide angle lens according to at least an embodiment of the present invention is characterized in that it includes a first lens, a second lens, a third lens, a fourth lens, an aperture, a fifth lens, a sixth lens, and a seventh lens, arranged in order from an object side, wherein the first lens is a negative meniscus lens having a convex surface facing the object side, the second lens is a negative meniscus lens having a concave surface facing an image side, the third lens is a negative lens having a concave surface facing the object side, the fourth lens is a positive lens having a convex surface facing the image side, the fifth lens is a positive lens, the sixth lens is a negative lens having a concave surface facing the image side, the seventh lens is a biconvex lens having convex surfaces facing both the object side and the image side, each of the third lens, the fourth lens, the sixth lens, and the seventh lens is a plastic lens, the third lens and the fourth lens constitute a first cemented lens in which a surface of the third lens on the image side and a surface of the fourth lens on the object side are joined by a resin material, and the sixth lens and the seventh lens constitute a second cemented lens in which a surface of the sixth lens on the image side and a surface of the seventh lens on the object side are joined by a resin material.

The wide angle lens according to at least an embodiment of the present invention includes the first lens, the second lens, the third lens, the fourth lens, the aperture, the fifth lens, the sixth lens, and the seventh lens, arranged in order from the object side, and the third lens and the fourth lens constitute a cemented lens (a first cemented lens) on the object side with respect to the aperture. This allows high positional accuracy between the surface of the third lens on the image side and the surface of the fourth lens on the object side. Therefore, the curvature of an image plane and inclination of an image plane may be sufficiently corrected. Further, chromatic aberrations may be properly corrected. Furthermore, on the image side with respect to the aperture, there is a triplet configuration in which the fifth lens, which is a positive lens, and a cemented lens (a second cemented lens) of the sixth lens, which is a negative lens, and the seventh lens, which is a positive lens, are disposed. For this reason, astigmatism, spherical aberrations, chromatic aberrations of magnification, and the like, may be sufficiently corrected. Moreover, in the second cemented lens, the concave surface of the sixth lens on the image side and the convex surface of the seventh lens on the object side are joined, whereby aberrations other than astigmatism, e.g., chromatic aberrations, may be properly corrected. Further, the chromatic aberration of the wide angle lens may be sufficiently corrected by arranging two cemented lenses, the first cemented lens and the second cemented lens. Therefore, a higher resolution may be achieved. Moreover, as the third lens, the fourth lens, the sixth lens, and the seventh lens are plastic lenses, cost reduction may be attained.

According to at least an embodiment of the present invention, it is possible to adopt the aspect in which, when a combined focal length of the third lens and the fourth lens is f34 (mm) and a combined focal length of the fifth lens, the sixth lens, and the seventh lens is f567 (mm), the combined focal lengths f34, f567 satisfy the following condition:

1<f34/f567<4.

According to this aspect, chromatic aberrations may be corrected in a well-balanced manner.

According to at least an embodiment of the present invention, it is possible to adopt the aspect in which, when a combined focal length of the third lens and the fourth lens is f34 (mm) and a combined focal length of an entire lens system is f0 (mm), the combined focal lengths f34, f0 satisfy the following condition:

2<f34/f0<9.

In this aspect, as f34/f0 exceeds 2 (the lower limit), it is possible to prevent the power of the lens disposed on the object side from being too strong. Therefore, various aberrations such as the curvature of an image plane, chromatic aberrations of magnification, or coma aberrations may be properly corrected, and high optical characteristics may be realized. Further, as f34/f0 is less than 9 (the upper limit), it is possible to prevent the lens diameter from being too large and to prevent the overall length of the entire lens system from being long. Therefore, the size of the wide angle lens may be reduced.

According to at least an embodiment of the present invention, it is possible to adopt the aspect in which, when the focal length of the fifth lens is f5 (mm) and the combined focal length of the entire lens system is f0 (mm), the combined focal lengths f5, f0 satisfy the following condition:

2<f5/f0<4.

In this aspect, as f5/f0 exceeds 2 (the lower limit), it is possible to prevent the power of the lens disposed on the object side from being too strong. Therefore, various aberrations such as the curvature of an image plane, a chromatic aberration of magnification, or a coma aberration may be properly corrected, and a wide angle lens with desired optical characteristics may be achieved. Moreover, as f5/f0 is less than 4 (the upper limit), the lens diameter and the object-image distance may be reduced. Thus, the size of the wide angle lens may be reduced.

According to at least an embodiment of the present invention, it is possible to adopt the aspect in which, when the combined focal length of the fifth lens, the sixth lens, and the seventh lens is f567 (mm) and the combined focal length of the entire lens system is f0 (mm), the combined focal lengths f567, f0 satisfy the following condition:

2<f567/f0<4.

In this aspect, as f567/f0 exceeds 2 (the lower limit), it is possible to prevent the power of the lens group including the fifth lens, the sixth lens, and the seventh lens from being too strong. Therefore, each aberration, particularly a chromatic aberration, may be corrected in a more desired manner, and higher optical performance may be realized. Further, as f567/f0 is less than 4 (the upper limit), it is possible to prevent the lens diameter from being too large and to prevent the overall length of the entire lens system from being long. Therefore, the size of the wide angle lens may be reduced.

According to at least an embodiment of the present invention, it is possible to adopt the aspect in which, when the combined focal length of the first lens and the second lens is f12 (mm) and the combined focal length of the entire lens system is f0 (mm), the combined focal lengths f12, f0 satisfy the following condition:

0.5<|f12/f0|<2.5.

In this aspect, as |f12/f0| exceeds 0.5 (the lower limit), the curvature of an image plane may be suppressed. Further, as |f12/f0| is less than 2.5 (the upper limit), the view angle may be increased.

According to at least an embodiment of the present invention, it is possible to adopt the aspect in which, when the combined focal length of the first lens and the second lens is f12 (mm) and the combined focal length of the third lens, the fourth lens, the fifth lens, the sixth lens, and the seventh lens is f34567 (mm), the combined focal lengths f12, f34567 satisfy the following condition:

0.1<|f12/f34567|<1.

In this aspect, as the value of |f12/f34567| is less than 1 (the upper limit), it is possible to prevent the positive power from being too strong. Therefore, coma aberrations and astigmatism may be properly corrected. Further, as the value of |f12/f34567| exceeds 0.1 (the lower limit), it is possible to prevent the negative power from being too strong. Accordingly, an increase in the overall length of the lens system may be avoided. Therefore, the size of the wide angle lens may be reduced.

According to at least an embodiment of the present invention, it is possible to adopt the aspect in which, when the total length from a surface of the first lens on the object side to an image plane on an optical axis of the entire lens system is d0 (mm) and a combined focal length of the entire lens system is f0 (mm), the total length d0 and the combined focal length f0 satisfy a following condition:

10<d0/f0<18.

In this aspect, as the value of d0/f0 exceeds 10 (the lower limit), spherical aberrations and distortions may be properly corrected. Further, as the value of d0/f0 is less than 18 (the upper limit), it is possible to prevent the lens diameter from being too large and to prevent the overall length of the entire lens system from being long.

According to at least an embodiment of the present invention, it is possible to adopt the aspect in which, in each of the third lens and the fourth lens, at least one of a lens surface on the object side and a lens surface on the image side is aspheric.

According to at least an embodiment of the present invention, it is possible to adopt the aspect in which the fifth lens is a glass lens. In this aspect, as a change in the refractive index due to a temperature change is small, it is possible to improve the temperature characteristics of the wide angle lens. Therefore, a higher resolution may be realized over a wide temperature range.

According to at least an embodiment of the present invention, it is possible to adopt the aspect in which the fifth lens is a biconvex lens having convex surfaces facing both the object side and the image side.

According to at least an embodiment of the present invention, it is possible to adopt the aspect in which the third lens is a biconcave lens having concave surfaces facing both the object side and the image side, and the fourth lens is a biconvex lens having convex surfaces facing both the object side and the image side. In this aspect, as the third lens is a negative lens, it is possible to have a lens configuration in which the fourth lens and the fifth lens, which are positive lenses, are disposed on both sides (the object side and the image side) of the aperture. In such a lens configuration, both sides of the aperture are nearly symmetrical. Therefore, astigmatism and chromatic aberrations of magnification at the periphery may be reduced. Further, as the third lens, which is a negative lens, is disposed, the negative power on the front side of the fourth lens may be divided by the first lens, the second lens, and the third lens. Therefore, as the concave surface of the first lens on the image side may be shallow, manufacturing of the first lens is easy.

According to at least an embodiment of the present invention, it is possible to adopt the aspect in which, in the first cemented lens and the second cemented lens, the magnitude relationship between the refractive indices of the cemented lenses is symmetrical with respect to the aperture. In this aspect, as it is easy to cancel out the aberration generated on the object side with respect to the aperture and the aberration generated on the image side with respect to the aperture, astigmatism and the curvature of an image plane may be properly corrected. Therefore, a higher resolution may be achieved.

According to at least an embodiment of the present invention, it is possible to adopt the aspect in which, when the refractive index of the fourth lens is n4 and the Abbe number of the fourth lens is ν4, the refractive index n4 and the Abbe number ν4 respectively satisfy the following conditions:

n4≥1.6

ν4≤26.

In this aspect, as it is possible to properly correct chromatic aberrations of magnification, a higher resolution may be achieved. Further, as the refractive index n4 is large, the total length of the wide angle lens may be shortened.

According to at least an embodiment of the present invention, it is possible to adopt the aspect in which, when the refractive index of the sixth lens is n6 and the Abbe number of the sixth lens is ν6, the refractive index n6 and the Abbe number ν6 respectively satisfy the following conditions:

n6≥1.6

ν6≤26.

In this aspect, chromatic aberrations of magnification may be properly corrected, and a higher resolution may be achieved. Further, as the refractive index n6 is large, the total length of the wide angle lens may be shortened.

According to at least an embodiment of the present invention, it is possible to adopt the aspect in which, in the second lens, at least one of a lens surface on the object side and a lens surface on the image side is aspheric.

According to at least an embodiment of the present invention, it is possible to adopt the aspect in which the first lens is a glass lens. In this aspect, as the first lens disposed closest to the object side is a glass lens, the first lens is unlikely to be damaged, or the like.

According to at least an embodiment of the present invention, it is possible to adopt the aspect in which any one of a flange part surrounding a periphery of a lens surface of the third lens on the image side and a flange part surrounding a periphery of a lens surface of the fourth lens on the object side is provided with an end section abutting an outer circumferential surface of the other flange part and defining a position of the other flange part in a radial direction. In this aspect, it is possible to form the first cemented lens by joining the third lens and the fourth lens with high positional accuracy, and therefore chromatic aberrations may be properly corrected. Therefore, a higher resolution may be achieved.

According to at least an embodiment of the present invention, it is possible to adopt an aspect in which the end section is formed in a ring shape and abuts an entire circumference of the outer circumferential surface of the other flange part.

According to at least an embodiment of the present invention, the projection method is a stereoscopic projection method in which a peripheral image is larger than a central image. In the case of such a stereographic projection system, the occurrence of chromatic aberration increases; however, disposing the first cemented lens makes it possible to properly correct a chromatic aberration with the first cemented lens.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a cross-sectional view of a lens unit provided with a wide angle lens according to a first embodiment of the present invention.

FIG. 2 is an explanatory view showing surface numbers, and the like, of the wide angle lens shown in FIG. 1.

FIG. 3 is an explanatory view showing a spherical aberration of the wide angle lens shown in FIG. 1.

FIG. 4 is an explanatory view showing a chromatic aberration of magnification of the wide angle lens shown in FIG. 1.

FIG. 5 is an explanatory view showing astigmatism and distortion of the wide angle lens shown in FIG. 1.

FIG. 6 is an explanatory view showing a wide angle lens lateral aberration shown in FIG. 1.

FIG. 7 is a perspective view of a third lens and a fourth lens used in the wide angle lens shown in FIG. 1 as viewed from the image side.

FIG. 8 is a perspective view of a third lens and a fourth lens used in the wide angle lens shown in FIG. 1 as viewed from the object side.

FIG. 9 is an explanatory view showing surface numbers, and the like, of the wide angle lens according to a second embodiment of the present invention.

FIG. 10 is an explanatory view showing a spherical aberration of the wide angle lens shown in FIG. 9.

FIG. 11 is an explanatory view showing a chromatic aberration of magnification of the wide angle lens shown in FIG. 9.

FIG. 12 is an explanatory view showing astigmatism and distortion of the wide angle lens shown in FIG. 9.

FIG. 13 is an explanatory view showing a lateral aberration of the wide angle lens shown in FIG. 9.

### DETAILED DESCRIPTION

### First Embodiment

(Configuration of a Wide Angle Lens 100)

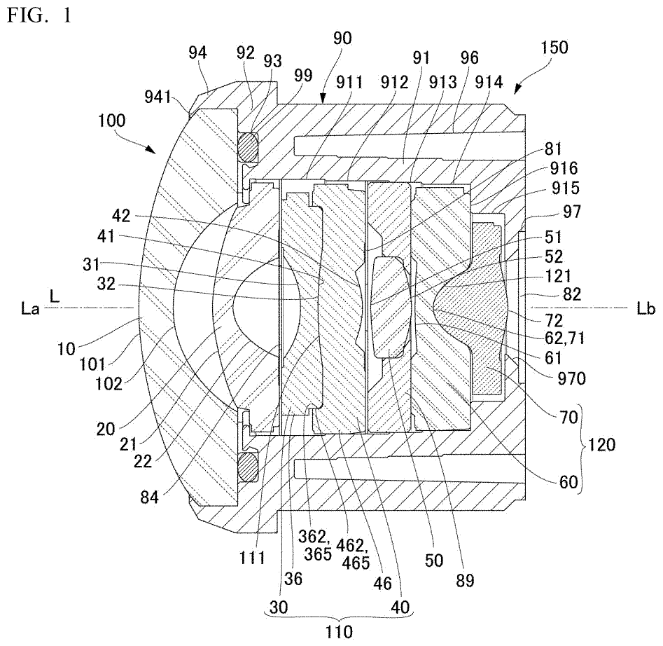

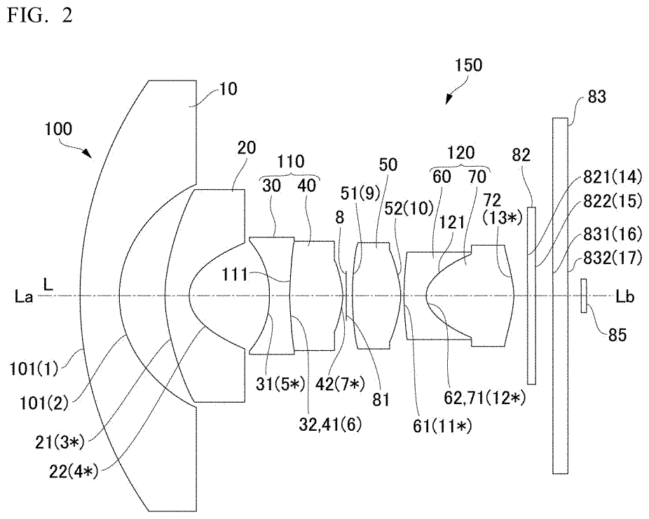

FIG. 1 is a cross-sectional view of a lens unit 150 provided with the wide angle lens 100 according to a first embodiment of the present invention. FIG. 2 is an explanatory view showing surface numbers, and the like, of the wide angle lens 100 shown in FIG. 1. Here, in describing the surface numbers in FIG. 2, an aspherical surface is attached with “*”.

As shown in FIG. 1, the lens unit 150 (wide angle lens unit) according to the present embodiment includes the wide angle lens 100 and a holder 90 that holds the wide angle lens 100 inside. According to the present embodiment, the wide angle lens 100 is configured as a wide angle lens having a horizontal angle of field of equal to or more than 150°.

As shown in FIG. 1 and FIG. 2, the wide angle lens 100 includes a first lens 10, a second lens 20, a third lens 30, a fourth lens 40, an aperture 81, a fifth lens 50, a sixth lens 60, and a seventh lens 70, arranged in order from the object side La to the image side Lb, and a flat-plate like infrared filter 82, a translucent cover 83, and an imaging device 85 are provided on the image side Lb with respect to the seventh lens 70. Further, a ring-shaped light shielding sheet 84 is disposed between the second lens 20 and the third lens 30.

The first lens 10 is a negative meniscus lens (a meniscus lens having negative power) having a convex surface facing the object side La and having a concave surface facing the image side Lb. The second lens 20 is a negative meniscus lens (a meniscus lens having negative power) having a concave surface facing the image side Lb and having a convex surface facing the object side La. The third lens 30 is a negative lens (lens having negative power) having a concave surface facing the object side La. The fourth lens 40 is a positive lens (lens having positive power) having a convex surface facing the image side Lb. The fifth lens 50 is a positive lens. The sixth lens 60 is a negative lens (lens having negative power) having a concave surface facing the image side Lb. The seventh lens 70 is a biconvex lens having convex surfaces facing both the object side La and the image side Lb and having positive power.

The third lens 30, the fourth lens 40, the sixth lens 60, and the seventh lens 70 are all plastic lenses. The third lens 30 and the fourth lens 40 constitute a first cemented lens 110 in which the surface of the third lens 30 on the image side Lb and the surface of the fourth lens 40 on the object side La are joined by a resin material 111, and the sixth lens 60 and the seventh lens 70 constitute a second cemented lens 120 in which the surface of the sixth lens 60 on the image side Lb and the surface of the seventh lens 70 on the object side La are joined by a resin material 121. According to the present embodiment, the resin material 111 and the resin material 121 are UV curing adhesives. The adhesive is a material having elasticity even after curing.

(Lens Configuration)

According to the present embodiment, as shown in FIG. 2, a lens surface 101 (a first surface 1) of the first lens 10 on the object side La is a spherical convex surface, and a lens surface 102 (a second surface 2) of the first lens 10 on the image side Lb is a spherical concave surface. In the second lens 20, at least one of the lens surface 21 on the object side La and the lens surface 22 on the image side Lb is aspheric. More specifically, the lens surface 21 (a third surface 3) of the second lens 20 on the object side La is an aspheric convex surface, and the lens surface 22 (a fourth surface 4) of the second lens 20 on the image side Lb is an aspheric concave surface.

In each of the third lens 30 and the fourth lens 40, at least one of the lens surface on the object side La and the lens surface on the image side Lb is aspheric. According to the present embodiment, the third lens 30 is a biconcave lens having concave surfaces facing both the object side La and the image side Lb. More specifically, in the third lens 30, a lens surface 31 (a fifth surface 5) on the object side La is an aspheric concave surface, and a lens surface 32 (a sixth surface 6) on the image side Lb is a spherical concave surface. The fourth lens 40 is a biconvex lens having convex surfaces facing both the object side La and the image side Lb. More specifically, in the fourth lens 40, a lens surface 41 on the object side La is a spherical convex surface having the same shape as that of the lens surface 32 of the third lens 30, and it forms the sixth surface 6. In the fourth lens 40, a lens surface 42 (a seventh surface) on the image side Lb is an aspheric convex surface.

The aperture 81 forms an eighth surface 8. The fifth lens 50 is a biconvex lens in which both a lens surface 51 (a ninth surface 9) on the object side La and a lens surface 52 (a tenth surface 10) on the image side Lb are spherical convex surfaces.

In each of the sixth lens 60 and the seventh lens 70, at least one of the lens surface on the object side La and the lens surface on the image side Lb is aspheric. According to the present embodiment, in the sixth lens 60, a lens surface 61 (an eleventh surface 11) on the object side La is an aspheric convex surface, and a lens surface 62 (a twelfth surface 12) on the image side Lb is an aspheric concave surface. In the seventh lens 70, the lens surface 71 on the object side La is an aspheric convex surface having the same shape as that of the lens surface 62 of the sixth lens 60, and it forms the twelfth surface 12. In the seventh lens 70, a lens surface 72 (a thirteenth surface) on the image side Lb is an aspheric convex surface.

A surface 821 of the infrared filter 82 on the object side La forms a fourteenth surface 14, and a surface 822 on the image side Lb forms a fifteenth surface 15. A surface 831 of the cover 83 on the object side La forms a sixteenth surface 16, and a surface 832 on the image side Lb forms a seventeenth surface 17.

Here, the first lens 10 and the fifth lens 50 are glass lenses, and the second lens 20, the third lens 30, the fourth lens 40, the sixth lens 60, and the seventh lens 70 are plastic lenses made of acrylic resin series, polycarbonate series, polyolefin series, or the like.

The configuration, and the like, of each lens of the wide angle lens 100 according to the present embodiment is as shown in Table 1, and Table 1 shows the following characteristics as the characteristics of the wide angle lens 100. According to the present embodiment, the projection method of the wide angle lens 100 is a stereographic projection method in which a peripheral image is larger than a central image.

Focal length f0 (Effective Focal Length) of the entire lens system

Total length (Total Track)

F-number of the whole lens system (Image Space F/#)

Maximum angle of field (Max. Field Angle)

Further, in Table 1, the following items of each surface are shown. The radius of curvature, the thickness, and the focal length are in the unit of mm. Here, when the lens surface is a convex surface protruding toward the object side or a concave surface recessed toward the object side, the curvature radius has a positive value, and when the lens surface is a convex surface protruding toward the image side or a concave surface recessed toward the image side, the curvature radius has a negative value.

Radius of curvature (Radius)

Thickness (Thickness)

Refractive index Nd

Abbe number νd

Focal length f

Furthermore, Table 1 also shows aspheric coefficients A4, A6, A8, and A10 when the shape of the aspheric surface is expressed by the following equation (Equation 1). In the following equation, the amount of sag (the axis in the optical axis direction) is z, the height in the direction perpendicular to the optical axis (beam height) is r, the conical coefficient is k, and the reciprocal of the radius of curvature is c.

$$Z = \frac{{cr}^{2}}{1 + \sqrt{1 - ( 1 + K ) {c}^{2} {r}^{2}}} + {\sum }_{n = 2}^{5} {A}_{2 n} {r}^{2 n}$$

TABLE 1

| Effective Focal Length | 0.855 | mm |
|---|---|---|
| Total Track | 12.198 | mm |
| Image Space F/# | 2.0 | |
| Max. Field of Angle | 204 | deg |

| Surf | Radius | Thickness | Nd | νd | f |
|---|---|---|---|---|---|
| 1 | 11.330 | 1.000 | 1.835 | 42.7 | −6.441 |
| 2 | 3.500 | 1.145 | | | |
| 3* | 4.478 | 0.600 | 1.512 | 56.2 | −2.818 |
| 4* | 1.041 | 1.990 | | | |
| 5* | −3.576 | 0.510 | 1.544 | 56.2 | −4.818 |
| 6 | 10.300 | 1.320 | 1.635 | 24.0 | 3.229 |
| 7* | −2.432 | 0.100 | | | |
| 8(stop) | Infinity | 0.141 | | | |
| 9 | 8.1 | 1.200 | 1.773 | 49.6 | 3.208 |
| 10 | −3.340 | 0.100 | | | |
| 11* | 7.980 | 0.550 | 1.635 | 24.0 | −1.245 |
| 12* | 0.700 | 2.180 | 1.544 | 56.2 | 1.317 |
| 13* | −2.982 | 0.350 | | | |
| 14 | Infinity | 0.210 | | | |
| 15 | Infinity | 0.392 | | | |
| 16 | Infinity | 0.400 | 1.517 | 64.1 | |
| 17 | Infinity | 0.010 | | | |

Aspheric Coefficient

| Surf | c (1/Radius) | K | A4 | A6 | A8 | A10 |
|---|---|---|---|---|---|---|
| 3 | 2.23314E−01 | 0.00000E+00 | −1.08000E−02 | 7.81000E−04 | −1.78500E−05 | 0.00000E+00 |
| 4 | 9.60615E−01 | −7.20000E−01 | −1.42000E−03 | −3.09000E−04 | 9.85000E−04 | 6.96000E−04 |
| 5 | −2.79642E−01 | 0.00000E+00 | −2.79000E−02 | −8.23000E−03 | −2.31000E−03 | 2.57000E−03 |
| 7 | −4.11184E−01 | 0.00000E+00 | 1.80000E−02 | −3.55000E−03 | 5.10000E−03 | 0.00000E+00 |
| 11 | 1.25313E−01 | 0.00000E+00 | −8.14000E−03 | −2.72000E−03 | 1.30000E−03 | −4.24000E−04 |
| 12 | 1.42857E+00 | −9.30000E−01 | 2.33000E−02 | −2.63000E−02 | 2.29000E−02 | −7.08000E−03 |
| 13 | −3.35345E−01 | −2.00000E+00 | 2.53000E−02 | −4.10000E−03 | −2.19000E−03 | 1.65000E−03 |

As shown in Table 1, in the wide angle lens 100 according to the present embodiment, the focal length f0 of the entire lens system is 0.855 mm, the total length is 12.198 mm, the F-number of the entire lens system is 2.0, the maximum angle of field is 204 deg, and the horizontal angle of field is equal to or more than 150 deg.

In the first cemented lens 110 and the second cemented lens 120, the magnitude relationship between the refractive indices of the cemented lenses is symmetrical with respect to the aperture 81. More specifically, in the first cemented lens 110, the refractive index Nd of the third lens 30 is 1.544, and the refractive index Nd of the fourth lens 40 is 1.635. Therefore, in the first cemented lens 110, the refractive index Nd of the third lens 30 on the object side La is larger than the refractive index Nd of the fourth lens 40 on the image side Lb. On the other hand, in the second cemented lens 120, the refractive index Nd of the sixth lens 60 is 1.635, and the refractive index Nd of the seventh lens 70 is 1.544. Therefore, in the second cemented lens 120, the refractive index Nd of the seventh lens 70 on the image side Lb is larger than the refractive index Nd of the sixth lens 60 on the object side La.

Further, when the refractive index of the fourth lens 40 is n4 and the Abbe number of the fourth lens 40 is ν4, the refractive index n4 and the Abbe number ν4 respectively satisfy the following conditions:

n4≥1.6

ν4≤26.

According to the present embodiment, the refractive index n4 of the fourth lens 40 is 1.635, and the Abbe number ν4 of the fourth lens 40 is 24.0, which satisfy the above expression.

Further, when the refractive index of the sixth lens 60 is n6 and the Abbe number of the sixth lens 60 is ν6, the refractive index n6 and the Abbe number ν6 respectively satisfy the following conditions:

n6≥1.6

ν6≤26.

According to the present embodiment, the refractive index n6 of the sixth lens 60 is 1.635, and the Abbe number ν6 of the sixth lens 60 is 24.0, which satisfy the above expression.

(Aberration Property of the Wide Angle Lens 100)

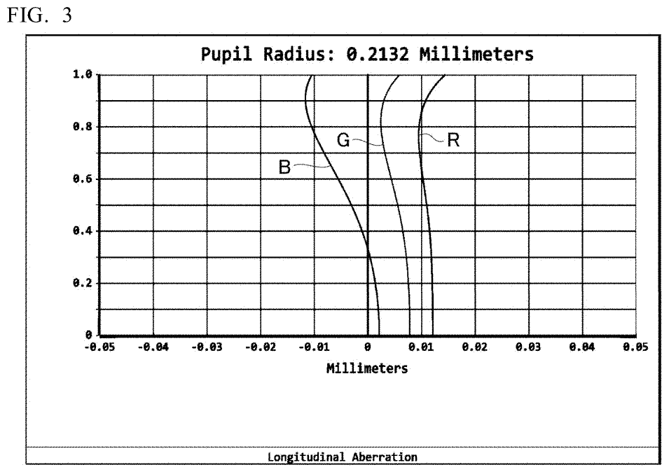

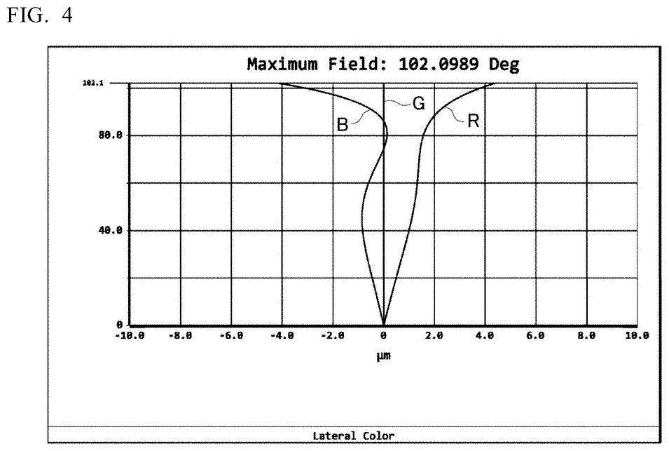

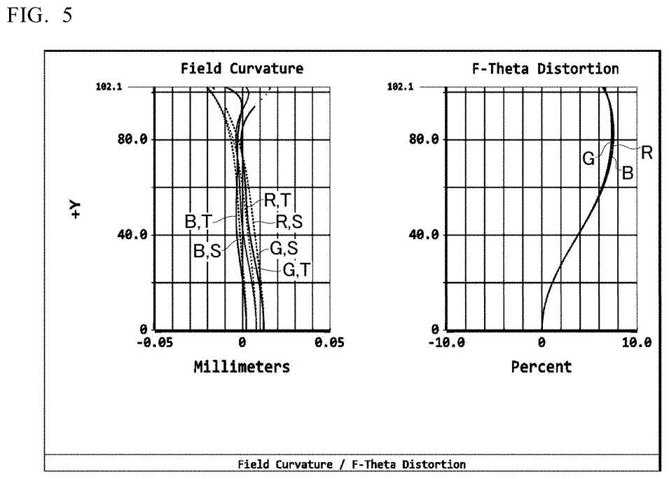

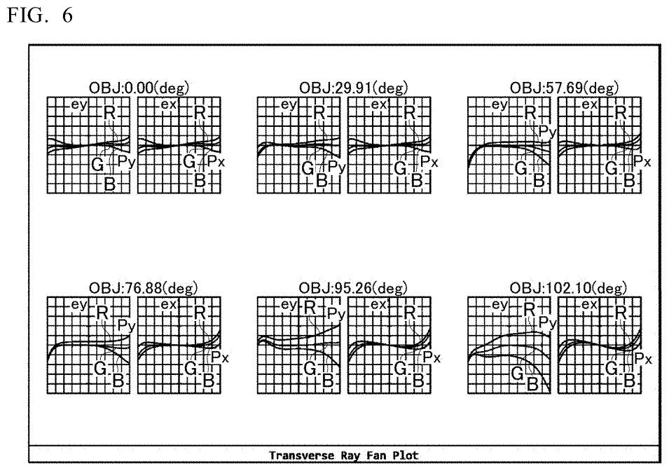

FIG. 3 is an explanatory view showing the spherical aberration of the wide angle lens 100 shown in FIG. 1. FIG. 4 is an explanatory view showing a chromatic aberration of magnification of the wide angle lens 100 shown in FIG. 1 and showing a chromatic aberration of magnification at the maximum angle of field (102.0989 deg/half angle). FIG. 5 is an explanatory view showing astigmatism and distortion of the wide angle lens 100 shown in FIG. 1. FIG. 6 is an explanatory view showing the lateral aberration of the wide angle lens 100 shown in FIG. 1.

Here, FIG. 3, FIG. 4, and FIG. 5 show each aberration in red light R (a wavelength of 656 nm), green light G (a wavelength of 588 nm), and blue light B (a wavelength of 486 nm). Furthermore, with regard to the astigmatism shown in FIG. 5, S is assigned to a feature in the sagittal direction, and T is assigned to a feature in the tangential direction. Moreover, the distortion shown in FIG. 5 indicates the change ratio of an image in the central part for capturing and in the peripheral part, and it may be said that the smaller the absolute value of the numerical value representing the distortion, the more accurate the lens. FIG. 6 collectively shows lateral aberrations in two directions (the y-direction and the x-direction) perpendicular to the optical axis at each angle, 0.00 deg, 29.91 deg, 57.69 deg, 76.08 deg, 95.26 deg, and 102.10 deg of the red light R (a wavelength of 656 nm), the green light G (a wavelength of 588 nm), and the blue light B (a wavelength of 486 nm).

As shown in FIG. 3 to FIG. 6, with the wide angle lens 100 according to the present embodiment, spherical aberrations, chromatic aberrations of magnification, astigmatism (distortions), and lateral aberrations are corrected to appropriate levels.

(Configuration of the holder 90, etc.)

The holder 90 shown in FIG. 1 is made of resin and, in the direction of the optical axis L, includes: a bottom plate part 97 located at the rearmost side; a cylindrical barrel part 91 extending from the outer peripheral edge of the bottom plate part 97 to the front side (the object side La); a ring-shaped receiving part 92 located at the front edge of the cylindrical barrel part 91 and having a larger diameter toward an outer side in the radial direction; and a large-diameter cylindrical part 94 having an inner diameter larger than the cylindrical barrel part 91 and extending from the outer peripheral edge of the receiving part 92 to the front side (the object side La). In the holder 90, an opening part 970 is formed in the bottom plate part 97, and an infrared filter 82 is held on the surface of the bottom plate part 97 on the image side Lb.

Inside the cylindrical barrel part 91 of the holder 90, a first accommodating part 911, a second accommodating part 912 having a smaller inner diameter than the first accommodating part 911, a third accommodating part 913 having a smaller inner diameter than the second accommodating part 912, a fourth accommodating part 914 having a smaller inner diameter than the third accommodating part 913, and a fifth accommodating part 915 having a smaller inner diameter than the fourth accommodating part 914 are formed in order from the object side La to the image side Lb. To meet this configuration, a recess section 96 having a recess from the image side Lb toward the object side La is formed in a ring shape in the cylindrical barrel part 91. Further, on the inner circumferential surface of the recess section 96, an end section is formed to reduce the difference in the thickness between the first accommodating part 911, the second accommodating part 912, the third accommodating part 913, the fourth accommodating part 914, and the fifth accommodating part 915. For this reason, when the holder 90 is manufactured by resin molding, a reduction in the dimensional accuracy resulting from sink marks of resin may be suppressed.

According to the present embodiment, in the second cemented lens 120, as the outer diameter of the sixth lens 60 is larger than the outer diameter of the seventh lens 70, the part of the sixth lens 60 protruding outward in the radial direction from the seventh lens 70 is in contact with an end section 916 between the fourth accommodating part 914 and the fifth accommodating part 915. Further, inside the cylindrical barrel part 91, the fifth lens 50, the aperture 81, the first cemented lens 110, the light shielding sheet 84, and the second lens 20 are sequentially arranged in an overlapped manner on the object side La with respect to the second cemented lens 120. Here, the fifth lens 50 is held by the holder 90 via a cylindrical member 89. Further, the outer diameter of the first lens 10 is larger than the inner diameter of the cylindrical barrel part 91, and the first lens 10 is disposed so as to abut the receiving part 92 inside the cylindrical part 94. In addition, an O-ring 99 is disposed in a ring-shaped groove 93 formed in the receiving part 92 between the first lens 10 and the receiving part 92, and in this state, the end of the cylindrical part 94 on the object side La is swaged so that the first lens 10 is secured.

(Configuration of the First Cemented Lens 110)

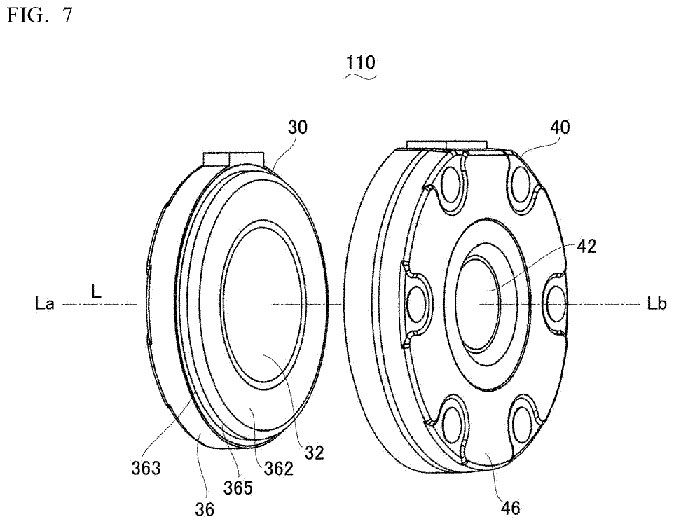

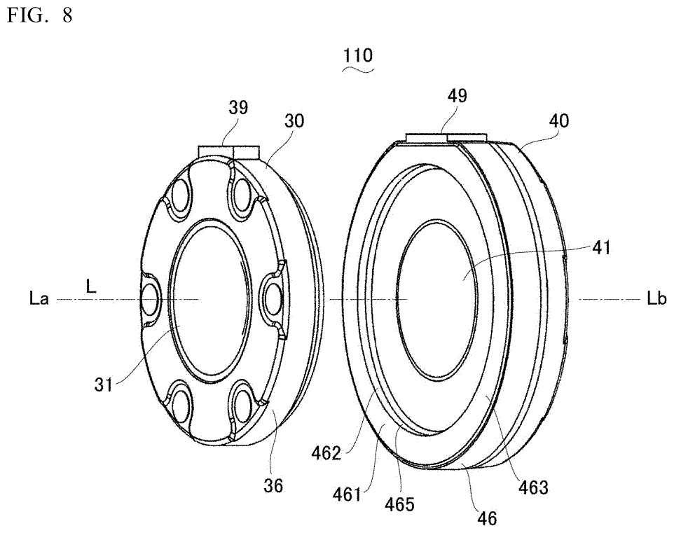

FIG. 7 is a perspective view of the third lens 30 and the fourth lens 40 used in the wide angle lens 100 shown in FIG. 1 as viewed from the image side Lb. FIG. 8 is a perspective view of the third lens 30 and the fourth lens 40 used in the wide angle lens 100 shown in FIG. 1 as viewed from the object side La.

As shown in FIG. 7 and FIG. 8, the third lens 30 used for the first cemented lens 110 has a flange part 36 around the lens surfaces 31 and 32. Further, a surface 363 of the flange part 36 at the image side Lb includes a ring-shaped protrusion section 362 that protrudes to the image side Lb around the lens surface 32. On the other hand, the fourth lens 40 used for the first cemented lens 110 includes a flange part 46 around the lens surfaces 41 and 42. Furthermore, a surface 463 of the flange part 46 on the object side La includes a recess section 462 that is recessed toward the image side Lb around the lens surface 41, and the inner diameter of the recess section 462 is substantially equal to the outer diameter of the protrusion section 362 of the third lens 30.

Therefore, when the surface of the third lens 30 on the image side Lb and the surface of the fourth lens 40 on the object side La are joined with the resin material 111, the protrusion section 362 of the third lens 30 is fitted into the recess section 462 of the fourth lens 40. Thus, an end section 465 formed of the inner circumferential surface of the recess section 462 of the fourth lens 40 abuts the outer circumferential surface 365 of the protrusion section 362 of the flange part 36, and the end section 465 defines the position of the flange part 36 in the radial direction. As a result, the third lens 30 and the fourth lens 40 are joined with high positional accuracy in the radial direction. According to the present embodiment, as the end section 465 is formed in a ring shape, it abuts the entire circumference of the outer circumferential surface 365 of the protrusion section 362 of the flange part 36, and the third lens 30 and the fourth lens 40 are joined with high positional accuracy in the radial direction.

(Primary Effect of the Present Embodiment)

As described above, the wide angle lens 100 according to the present embodiment includes the first lens 10, the second lens 20, the third lens 30, the fourth lens 40, the aperture 81, the fifth lens 50, the sixth lens 60, and the seventh lens 70, which are disposed in order from the object side La, and the third lens 30 and the fourth lens 40 form the cemented lens (the first cemented lens 110) on the object side La with respect to the aperture 81. This allows high positional accuracy obtained between the surface of the third lens 30 on the image side Lb and the surface of the fourth lens 40 on the object side La. Therefore, the curvature of an image plane and inclination of an image plane may be sufficiently corrected. In addition, chromatic aberrations may be properly corrected. Furthermore, the image side Lb with respect to the aperture 81 has a triplet configuration in which the fifth lens 50, which is a positive lens, and the cemented lens (the second cemented lens 120) of the sixth lens 60, which is a negative lens, and the seventh lens 70, which is a positive lens, are disposed. For this reason, astigmatism, spherical aberrations, chromatic aberrations of magnification, and the like, may be sufficiently corrected. Further, in the second cemented lens 120, as the concave surface of the sixth lens 60 on the image side Lb and the convex surface of the seventh lens 70 on the object side La are joined, aberrations other than astigmatism, for example, chromatic aberrations, may be appropriately corrected. Further, as the two cemented lenses, the first cemented lens 110 and the second cemented lens 120, are disposed, chromatic aberrations of the wide angle lens 100 may be sufficiently corrected. Therefore, higher resolution may be realized. Moreover, as the third lens 30, the fourth lens 40, the sixth lens 60, and the seventh lens 70 are plastic lenses, cost reduction may be achieved. Further, according to the present embodiment, as the second lens 20 is also a plastic lens, cost reduction and weight reduction may be further achieved.

Furthermore, the third lens 30 is a biconcave lens, and the fourth lens 40 is a biconvex lens. For this reason, it is possible to provide a lens configuration in which the fourth lens 40 and the fifth lens 50, which are formed of positive lenses, are disposed on both sides (the object side La and the image side Lb) of the aperture 81, and this lens configuration is a configuration in which the two sides of the aperture 81 are nearly symmetrical. Therefore, astigmatism and chromatic aberrations of magnification at the peripheral part may be reduced. Thus, a higher resolution may be realized. Furthermore, as the third lens 30, which is a negative lens, is disposed, the negative power on the front side of the fourth lens 40 may be divided by the first lens 10, the second lens 20, and the third lens 30. Therefore, as the concave surface (the lens surface 102) of the first lens 10 on the image side Lb may be shallow, manufacturing of the first lens 10 is facilitated. In particular, according to the present embodiment, as the first lens 10 is a glass lens, manufacturing of the first lens 10 is facilitated when the concave surface (the lens surface 102) of the first lens 10 on the image side Lb is shallow.

Further, in the first cemented lens 110, the end section 465 formed of the inner circumferential surface of the recess section 462 of the fourth lens 40 abuts the outer circumferential surface 365 of the protrusion section 362 of the flange part 36, and the end section 465 defines the position of the flange part 36 in the radial direction. Therefore, the third lens 30 and the fourth lens 40 are joined with high positional accuracy in the radial direction even when the radius of curvature of the lens surface 32 of the third lens 30 on the image side Lb and the lens surface 41 of the fourth lens 40 on the object side La is large and it is, therefore, difficult to align the positions of the lens surface 31 of the third lens 30 and the lens surface 41 of the fourth lens 40. Thus, chromatic aberrations of the wide angle lens 100 may be properly corrected. Hence, a higher resolution may be realized.

Furthermore, the fifth lens 50 is a glass lens. For this reason, a change in the refractive index due to a temperature change is small, whereby the temperature characteristic of the wide angle lens 100 may be improved. Specifically, as the fifth lens 50, which is a glass lens, may suppress defocus of the wide angle lens 100 due to a temperature change, the temperature characteristic of the wide angle lens 100 may be improved. Therefore, a higher resolution may be realized over a wide range of temperatures. Further, the fifth lens 50 is a biconvex lens having convex surfaces facing both the object side La and the image side Lb. Therefore, it is easy to form, on the image side Lb with respect to the aperture 81, a triplet configuration in which the fifth lens 50, which is a positive lens, and the cemented lens (the second cemented lens 120) of the sixth lens 60, which is a negative lens, and the seventh lens 70, which is a positive lens, are disposed. Moreover, as the fifth lens 50 has sufficient positive power, the amount of sag of the sixth lens 60 and the seventh lens 70 may be reduced, for example, so that the configurations of the sixth lens 60 and the seventh lens 70 may be simplified. Moreover, as the first lens 10 disposed closest to the object side La is a glass lens, the first lens 10 is unlikely to be damaged, or the like.

Further, in the first cemented lens 110 and the second cemented lens 120, the magnitude relationship between the refractive indices of the cemented lenses is symmetrical with the aperture 81 interposed therebetween. Therefore, the aberration generated on the object side La with respect to the aperture 81 and the aberration generated on the image side Lb with respect to the aperture 81 may be easily canceled out, whereby astigmatism and the curvature of an image plane may be properly corrected.

Further, the refractive index n4 and the Abbe number ν4 of the fourth lens 40 satisfy the following conditions:

n4≥1.6

ν4≤26.

Therefore, chromatic aberrations of magnification may be properly corrected, whereby a higher resolution may be achieved. Further, the entire length of the wide angle lens 100 may be shortened.

Further, the refractive index n6 and the Abbe number ν6 of the sixth lens 60 satisfy the following conditions:

n6≥1.6

ν6≤26.

Therefore, chromatic aberrations of magnification may be properly corrected, whereby a higher resolution may be achieved. Further, the entire length of the wide angle lens 100 may be shortened. In such a configuration, chromatic dispersion tends to increase as the Abbe number ν6 of the sixth lens 60 decreases; however, in the first cemented lens 110 disposed on the opposite side of the second cemented lens 120 with respect to the aperture 81, the Abbe number ν4 of the fourth lens 40 is small. Therefore, in the first cemented lens 110 and the second cemented lens 120, the magnitude relationship of the Abbe numbers of the cemented lenses is symmetrical with respect to the aperture 81. Thus, it is easy to cancel out the chromatic aberration of magnification generated on the object side La with respect to the aperture 81 and the chromatic aberration of magnification generated on the image side Lb with respect to the aperture 81, whereby a chromatic aberration of magnification may be reduced.

Furthermore, in the second lens 20, at least one of the lens surface 21 on the object side La and the lens surface 22 on the image side Lb is aspheric. According to the present embodiment, both of the lens surface 21 on the object side La and the lens surface 22 on the image side Lb are aspheric. Furthermore, the lens surface 31 of the third lens 30 on the object side La and the lens surface 42 of the fourth lens 40 on the image side Lb are aspheric. Moreover, the lens surfaces 61 and 62 of the sixth lens 60 on the object side La and the image side Lb and the lens surfaces 71 and 72 of the seventh lens 70 on the object side La and the image side Lb are aspheric. Thus, spherical aberration and the like may be properly corrected.

According to the present embodiment, the projection method of the wide angle lens 100 is a stereographic projection in which a peripheral image is larger than a central image. In the case of such a stereographic projection system, the occurrence of chromatic aberrations increases; however, the first cemented lens 110 can properly correct the chromatic aberration as the first cemented lens 110 is provided.

Further, with regard to the wide angle lens 100 according to the present embodiment, combined focal lengths are shown in Table 2, and each of the values related to the conditional expressions (1) to (7) described below is shown in Table 3 as they satisfy the conditional expressions (1) to (7). Here, Table 3 also describes each value according to a second embodiment mentioned later. Furthermore, the values shown in Table 3 and the values described below are subjected to fractional processing by rounding off.

TABLE 2

| Surf | fa | fb | fc |
|---|---|---|---|
| 1 | f12 = −1.697 | f1234 = −26.153 | |
| 2 | | | |
| 3* | | | |
| 4* | | | |
| 5* | f34 = 6.193 | | f3456 = 2.103 |
| 6 | | | |
| 7* | | | |
| 8(stop) | | | |
| 9 | | f567 = 2.845 | |
| 10 | | | |
| 11* | f67 = 7.010 | | |
| 12* | | | |
| 13* | | | |
| 14 | | | |
| 15 | | | |
| 16 | | | |
| 17 | | | |

TABLE 3

| | | FIRST | SECOND |
|---|---|---|---|
| | | EMBODI- | EMBODI- |
| | | MENT | MENT |
| CONDITIONAL | 1 < f34/f567 < 4 | 2.176 | 2.127 |
| EXPRESSION (1) | | | |
| CONDITIONAL | 2 < f34/f0 < 9 | 7.246 | 6.947 |
| EXPRESSION (2) | | | |
| CONDITIONAL | 2 < f5/f0 < 4 | 3.753 | 3.450 |
| EXPRESSION (3) | | | |
| CONDITIONAL | 2 < f567/f0 < 4 | 3.329 | 3.265 |
| EXPRESSION (4) | | | |
| CONDITIONAL | 0.5 < \|f12/f0\| < 2.5 | 1.985 | 1.989 |
| EXPRESSION (5) | | | |
| CONDITIONAL | 0.1 < \|f12/f34567\| < 1 | 0.807 | 0.857 |
| EXPRESSION (6) | | | |
| CONDITIONAL | 10 < d0/f0 < 18 | 14.272 | 13.517 |
| EXPRESSION (7) | | | |

As shown in Table 1, according to the present embodiment, a total length d0 (Total Track), which is the distance from the lens surface 101 of the first lens 10 on the object side La to the image plane on the optical axis of the entire lens system, is 12.198 mm, and a combined focal length f0 of the entire lens system is 0.855 mm. The focal lengths of the first lens 10, the second lens 20, the third lens 30, the fourth lens 40, the fifth lens 50, the sixth lens 60, and the seventh lens 70 are −6.441 mm, −2.818 mm, −4.818 mm, 3.229 mm, 3.208 mm, −1.245 mm, and 1.317 mm, respectively.

As shown in Table 2, a combined focal length f12 of the first lens 10 and the second lens 20, the focal length of the first cemented lens 110 (a combined focal length f34 of the third lens 30 and the fourth lens 40), and the focal length of the second cemented lens 120 (a combined focal length f67 of the sixth lens 60 and the seventh lens 70) are −1.697 mm, 6.193 mm, and 7.010 mm, respectively. A combined focal length f1234 of the first lens 10, the second lens 20, the third lens 30, and the fourth lens 40 is −26.153 mm. A combined focal length f567 of the fifth lens 50, the sixth lens 60, and the seventh lens 70 is 2.845 mm. A combined focal length f34567 of the third lens 30, the fourth lens 40, the fifth lens 50, the sixth lens 60, and the seventh lens 70 is 2.103 mm.

Therefore, as shown in Table 3, the wide angle lens 100 according to the present embodiment satisfies the conditional expressions (1) to (7) described below. First, the ratio (f34/f567) of the combined focal lengths f34 to f567 is 2.176, which satisfies the following conditional expression (1). Therefore, a chromatic aberration may be corrected in a well-balanced manner.

1<f34/f567<4 Conditional expression (1)

The ratio (f34/f0) of the combined focal length f34 to f0 is 7.246, which satisfies the following conditional expression (2). In this aspect, as f34/f0 exceeds 2 (the lower limit), it is possible to prevent the power of the lens disposed on the object side La from being too strong. Therefore, various aberrations such as the curvature of an image plane, a chromatic aberration of magnification, or a coma aberration may be properly corrected, and high optical characteristics may be realized. In addition, as f34/f0 is less than 9 (the upper limit), it is possible to prevent the lens diameter from being too large and to prevent the overall length of the entire lens system from being long. Therefore, the size of the wide angle lens 100 may be reduced.

2<f34/f0<9 Conditional expression (2)

The ratio (f5/f0) of the focal length f5 of the fifth lens 50 to the combined focal length f0 of the entire lens system is 3.753, which satisfies the following conditional expression (3). In this aspect, as f5/f0 exceeds 2 (the lower limit), it is possible to prevent the power of the lens disposed on the object side La from being too strong. Therefore, various aberrations such as the curvature of an image plane, a chromatic aberration of magnification, or a coma aberration may be properly corrected, and the wide angle lens 100 with desired optical characteristics may be realized. In addition, as f5/f0 is less than 4, it is possible to prevent the lens diameter from being too large and to prevent the overall length of the entire lens system from being long. Therefore, the size of the wide angle lens 100 may be reduced.

2<f5/f0<4 Conditional expression (3)

The ratio (f567/f0) of the combined focal length f567 to f0 is 3.329, which satisfies the following conditional expression (4). In this aspect, as f567/f0 exceeds 2 (the lower limit), it is possible to prevent the power of the lens group including the fifth lens 50, the sixth lens 60, and the seventh lens 70 from being too strong. Therefore, correction on each aberration, particularly a chromatic aberration, may be performed in a more desired manner, and higher optical performance may be realized. In addition, as f567/f0 is less than 4 (the upper limit), it is possible to prevent the lens diameter from being too large and to prevent the overall length of the entire lens system from being long. Therefore, the size of the wide angle lens may be reduced.

2<f567/f0<4 Conditional expression (4)

The absolute value (|f12/f0|) of the ratio of the combined focal length f12 to f0 is 1.985, which satisfies the following conditional expression (5). According to this aspect, as |f12/f0| exceeds 0.5 (the lower limit), the curvature of an image plane may be suppressed. Further, as |f12/f0| is less than 2.5 (the upper limit), the view angle may be increased.

0.5<|f12/f0|<2.5 Conditional expression (5)

The absolute value (|f12/f34567|) of the ratio of the combined focal length f12 to f34567 is 0.807, which satisfies the following conditional expression (6). In this aspect, as the value of |f12/f34567| is less than 1 (the upper limit), it is possible to prevent the positive power from being too strong. Therefore, a coma aberration and astigmatism may be properly corrected. Further, as the value of |f12/f34567| exceeds 0.1 (the lower limit), it is possible to prevent the negative power from being too strong. Therefore, it is possible to further prevent the overall length of the entire lens system from being long, and therefore it is possible to reduce the size of the wide angle lens.

0.1<|f12/f34567|<1 Conditional expression (6)

The ratio (d0/f0) of the total length d0 to the combined focal length f0 is 14.272, which satisfies the conditional expression (7). According to this aspect, as the value of d0/f0 exceeds 10 (the lower limit), a spherical aberration and distortion may be properly corrected. Further, as the value of d0/f0 is less than 18 (the upper limit), it is possible to prevent the lens diameter from being too large, and it is possible to prevent the overall length of the entire lens system from being long. Therefore, the size of the wide angle lens may be reduced.

10<d0/f0<18 Conditional expression (7)

### Second Embodiment

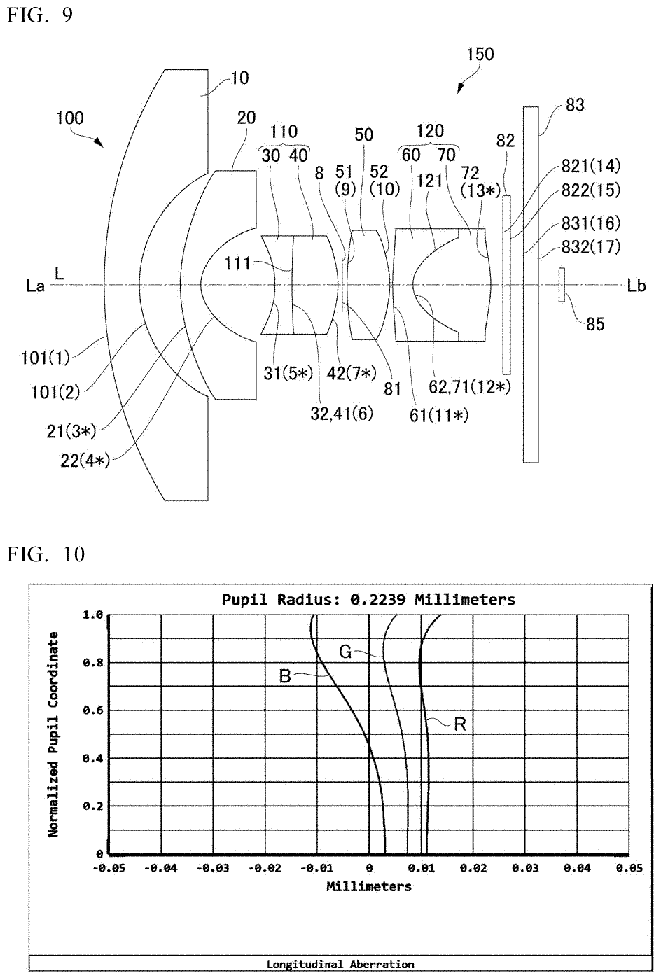

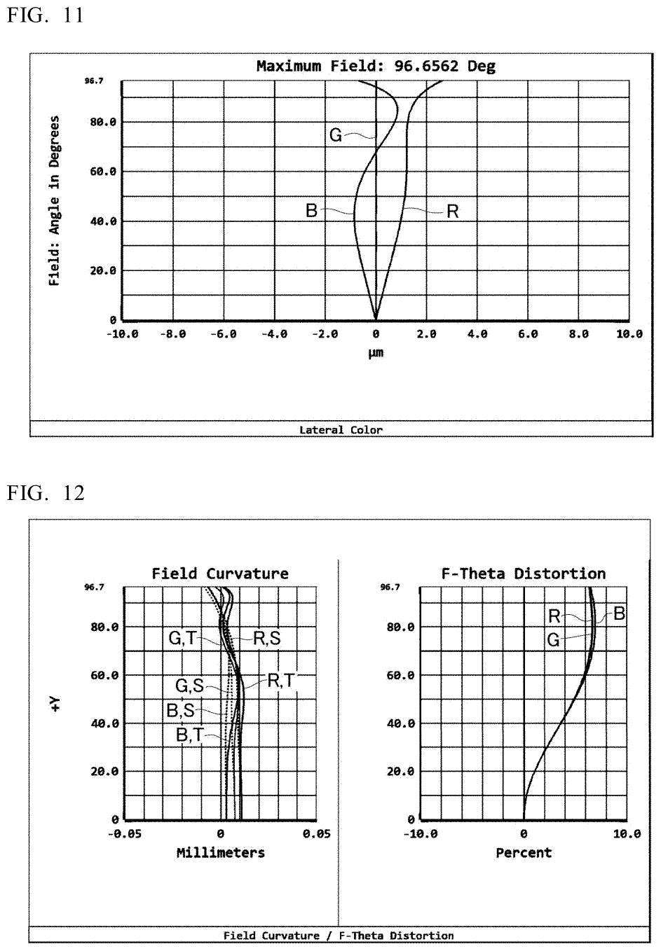

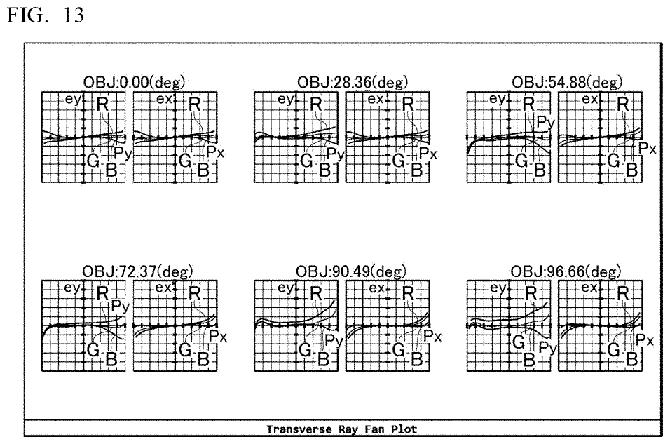

FIG. 9 is an explanatory view showing the surface numbers, and the like, of the wide angle lens 100 according to a second embodiment of the present invention. FIG. 10 is an explanatory view showing a spherical aberration of the wide angle lens 100 shown in FIG. 9. FIG. 11 is an explanatory view showing a chromatic aberration of magnification of the wide angle lens 100 shown in FIG. 9 and shows a chromatic aberration of magnification at the maximum angle of field (96.6562 deg/half angle). FIG. 12 is an explanatory view showing astigmatism and distortion of the wide angle lens 100 shown in FIG. 9. FIG. 13 is an explanatory view showing a lateral aberration of the wide angle lens 100 shown in FIG. 1. FIG. 10, FIG. 11, and FIG. 12 show aberrations in the red light R (a wavelength of 656 nm), the green light G (a wavelength of 588 nm), and the blue light B (a wavelength of 486 nm). FIG. 13 collectively shows lateral aberrations in two directions (the y-direction and the x-direction) perpendicular to the optical axis at each angle, 0.00 deg, 28.36 deg, 54.88 deg, 72.37 deg, 90.49 deg, and 96.66 deg of the red light R (a wavelength of 656 nm), the green light G (a wavelength of 588 nm), and the blue light B (a wavelength of 486 nm). Here, as the basic configuration according to the present embodiment is the same as that of the first embodiment, the corresponding parts are denoted by the same reference numerals, and the detailed description thereof are omitted.

As shown in FIG. 9, in the same manner as in the first embodiment, the wide angle lens 100 according to the present embodiment is also formed of the first lens 10, the second lens 20, the third lens 30, the fourth lens 40, the aperture 81, the fifth lens 50, the sixth lens 60, and the seventh lens 70, disposed in order from the object side La to the image side Lb, and the flat-plate like infrared filter 82, the translucent cover 83, and the imaging device 85 are provided in order on the image side Lb with respect to the seventh lens 70. The ring-shaped light shielding sheet 84 is disposed between the second lens 20 and the third lens 30. The projection method of the wide angle lens 100 is a stereoscopic projection in which a peripheral image is larger than a central image.

The first lens 10 is a negative meniscus lens having a convex surface facing the object side La and having a concave surface facing the image side Lb. The second lens 20 is a negative meniscus lens having a concave surface facing the image side Lb and having a convex surface facing the object side La. The third lens 30 is a negative lens having a concave surface facing the object side La. The fourth lens 40 is a positive lens having a convex surface facing the image side Lb. The fifth lens 50 is a positive lens. The sixth lens 60 is a negative lens having a concave surface facing the image side Lb. The seventh lens 70 is a biconvex lens having convex surfaces facing both the object side La and the image side Lb and having a positive power.

The third lens 30, the fourth lens 40, the sixth lens 60, and the seventh lens 70 are all plastic lenses. The third lens 30 and the fourth lens 40 constitute the first cemented lens 110 in which the surface of the third lens 30 on the image side Lb and the surface of the fourth lens 40 on the object side La are joined by a resin material, and the sixth lens 60 and the seventh lens 70 constitute the second cemented lens 120 in which the surface of the sixth lens 60 on the image side Lb and the surface of the seventh lens 70 on the object side La are joined by a resin material.

According to the present embodiment, the lens surface 101 (the first surface 1) of the first lens 10 on the object side La is a spherical convex surface, and the lens surface 102 (the second surface 2) of the first lens 10 on the image side Lb is a spherical concave surface. In the second lens 20, at least one of the lens surface 21 on the object side La and the lens surface 22 on the image side Lb is aspheric. More specifically, the lens surface 21 (the third surface 3) of the second lens 20 on the object side La is an aspheric convex surface, and the lens surface 22 (the fourth surface 4) of the second lens 20 on the image side Lb is an aspheric concave surface.

In each of the third lens 30 and the fourth lens 40, at least one of the lens surface on the object side La and the lens surface on the image side Lb is aspheric. According to the present embodiment, the third lens 30 is a biconcave lens having concave surfaces facing both the object side La and the image side Lb. More specifically, in the third lens 30, the lens surface 31 (the fifth surface 5) on the object side La is an aspheric concave surface, and the lens surface 32 (the sixth surface 6) on the image side Lb is a spherical concave surface. The fourth lens 40 is a biconvex lens having convex surfaces facing both the object side La and the image side Lb. More specifically, in the fourth lens 40, the lens surface 41 on the object side La is a spherical convex surface having the same shape as that of the lens surface 32 of the third lens 30, and it forms the sixth surface 6. In the fourth lens 40, the lens surface 42 (seventh surface) on the image side Lb is an aspheric convex surface.

The aperture 81 forms the eighth surface 8. The fifth lens 50 is a biconvex lens in which both the lens surface 51 (the ninth surface 9) on the object side La and the lens surface 52 (the tenth surface 10) on the image side Lb are spherical convex surfaces.

In each of the sixth lens 60 and the seventh lens 70, at least one of the lens surface on the object side La and the lens surface on the image side Lb is aspheric. According to the present embodiment, in the sixth lens 60, the lens surface 61 (the eleventh surface 11) on the object side La is an aspheric convex surface, and the lens surface 62 (the twelfth surface 12) on the image side Lb is an aspheric concave surface. In the seventh lens 70, the lens surface 71 on the object side La is an aspheric convex surface having the same shape as that of the lens surface 62 of the sixth lens 60, and it forms the twelfth surface 12. Furthermore, in the seventh lens 70, the lens surface 72 (the thirteenth surface) on the image side Lb is an aspheric convex surface.

Further, the surface 821 of the infrared filter 82 on the object side La forms the fourteenth surface 14, and the surface 822 on the image side Lb forms the fifteenth surface 15. The surface 831 of the cover 83 on the object side La forms the sixteenth surface 16, and the surface 832 on the image side Lb forms the seventeenth surface 17.

Here, the first lens 10 and the fifth lens 50 are glass lenses, and the second lens 20, the third lens 30, the fourth lens 40, the sixth lens 60, and the seventh lens 70 are plastic lenses made of acrylic resin series, polycarbonate series, polyolefin series, or the like.

The configuration, and the like, of each lens of the wide angle lens 100 according to the present embodiment is as shown in Table 4; the focal length f0 of the entire lens system is 0.904, the total length d0 (Total Track) is 12.225 mm, the F-number of the entire lens system is 2.0, and the maximum angle of field is 193 deg.

TABLE 4

| Effective Focal Length | 0.904 | mm |
|---|---|---|
| Total Track | 12.225 | mm |
| Image Space F/# | 2.0 | |
| Max. Field of Angle | 193 | deg |

| Surf | Radius | Thickness | Nd | νd | f | fa | fb | fc |
|---|---|---|---|---|---|---|---|---|
| 1 | 11.400 | 1.000 | 1.835 | 42.7 | −6.286 | f12 = −1.799 | f1234 = −38.797 | |
| 2 | 3.450 | 1.150 | | | | | | |
| 3* | 4.550 | 0.600 | 1.512 | 56.2 | −3.105 | | | |
| 4* | 1.125 | 2.040 | | | | | | |
| 5* | −3.448 | 0.510 | 1.544 | 56.2 | −5.275 | f34 = 6.282 | | f34567 = 2.099 |
| 6 | 18.000 | 1.285 | 1.635 | 24.0 | 3.404 | | | |
| 7* | −2.388 | 0.100 | | | | | | |
| 8 (stop) | Infinity | 0.141 | | | | | | |
| 9 | 8.080 | 1.200 | 1.773 | 49.6 | 3.120 | | f567 = 2.953 | |
| 10 | −3.213 | 0.100 | | | | | | |
| 11* | 8.643 | 0.550 | 1.635 | 24.0 | −1.233 | f67 = 10.280 | | |
| 12* | 0.700 | 2.200 | 1.544 | 56.2 | 1.313 | | | |
| 13* | −3.797 | 0.350 | | | | | | |
| 14 | Infinity | 0.210 | | | | | | |
| 15 | Infinity | 0.379 | | | | | | |
| 16 | Infinity | 0.400 | 1.517 | 64.1 | | | | |
| 17 | Infinity | 0.010 | | | | | | |

| Surf | c (1/Radius) | K | A4 | A6 | A8 | A10 |
|---|---|---|---|---|---|---|
| 3 | 2.19780E−01 | 0.00000E+00 | −4.10000E−03 | −2.40000E−04 | 3.60000E−05 | −2.00000E−08 |
| 4 | 8.88889E−01 | −6.30000E−01 | 2.22000E−03 | 1.20000E−03 | 1.92000E−03 | −2.74000E−04 |
| 5 | −2.90065E−01 | 0.00000E+00 | −2.90000E−02 | −1.60000E−03 | −6.17000E−03 | 3.08000E−03 |
| 7 | −4.18796E−01 | 0.00000E+00 | 2.13000E−02 | −5.63000E−03 | 5.87000E−03 | 0.00000E+00 |
| 11 | 1.15701E−01 | 0.00000E+00 | −3.52000E−03 | −1.04000E−02 | 7.60000E−03 | −2.68000E−03 |
| 12 | 1.42857E+00 | −9.30000E−01 | 4.86000E−02 | −7.66000E−02 | 6.02000E−02 | −1.89000E−02 |
| 13 | −2.63401E−01 | −2.00000E+00 | 2.85000E−02 | −8.44000E−03 | 2.71000E−04 | 1.17000E−03 |

In the first cemented lens 110 and the second cemented lens 120, the magnitude relationship between the refractive indices of the cemented lenses is symmetrical with respect to the aperture 81. More specifically, in the first cemented lens 110, the refractive index Nd of the third lens 30 is 1.544, and the refractive index Nd of the fourth lens 40 is 1.635. Therefore, in the first cemented lens 110, the refractive index Nd of the third lens 30 on the object side La is larger than the refractive index of the fourth lens 40 on the image side Lb. On the other hand, in the second cemented lens 120, the refractive index Nd of the sixth lens 60 is 1.635, and the refractive index Nd of the seventh lens 70 is 1.544. Therefore, in the second cemented lens 120, the refractive index Nd of the seventh lens 70 on the image side Lb is larger than the refractive index of the sixth lens 60 on the object side La. Therefore, it is easy to cancel out the aberration generated on the object side La with respect to the aperture 81 and the aberration generated on the image side Lb with respect to the aperture 81, whereby astigmatism and the curvature of an image plane may be properly corrected.

The refractive index n4 of the fourth lens 40 is 1.635, and the Abbe number ν4 of the fourth lens 40 is 24.0, and they satisfy the following expressions:

n4≥1.6

ν4≤26

Therefore, a chromatic aberration of magnification may be properly corrected, and a higher resolution may be achieved. Further, the entire length of the wide angle lens 100 may be shortened.

The refractive index n6 of the sixth lens 60 is 1.635, and the Abbe number ν6 of the sixth lens 60 is 24.0, and they satisfy the following expressions:

n6≥1.6

ν6≤2,6

Therefore, a chromatic aberration of magnification may be properly corrected, and a higher resolution may be achieved. Further, the entire length of the wide angle lens 100 may be shortened. In such a configuration, chromatic dispersion tends to increase as the Abbe number ν6 of the sixth lens 60 decreases; however, in the first cemented lens 110 disposed on the opposite side of the second cemented lens 120 with respect to the aperture 81, too, the Abbe number ν4 of the fourth lens 40 is small. Therefore, in the first cemented lens 110 and the second cemented lens 120, the magnitude relationship of the Abbe numbers of the cemented lenses is symmetrical with respect to the aperture 81. Thus, it is easy to cancel out the chromatic aberration of magnification generated on the object side La with respect to the aperture 81 and the chromatic aberration of magnification generated on the image side Lb with respect to the aperture 81, whereby a chromatic aberration of magnification may be reduced. Accordingly, in the first cemented lens 110 and the second cemented lens 120, the magnitude relationship of Abbe numbers of the cemented lenses is symmetrical with respect to the aperture 81. Therefore, it is easy to cancel out a chromatic aberration of magnification generated on the object side La with respect to the aperture 81 and a chromatic aberration of magnification generated on the image side Lb with respect to the aperture 81, whereby chromatic aberrations of magnification may be reduced.

In the wide angle lens 100 according to the present embodiment, the focal lengths of the first lens 10, the second lens 20, the third lens 30, the fourth lens 40, the fifth lens 50, the sixth lens 60, and the seventh lens 70 are −6.286 mm, −3.105 mm, −5.275 mm, 3.404 mm, 3.120 mm, −1.233 mm, and 1.313 mm, respectively.

The combined focal length f12 of the first lens 10 and the second lens 20, the focal length of the first cemented lens 110 (the combined focal length f34 of the third lens 30 and the fourth lens 40), and the focal length of the second cemented lens 120 (the combined focal lengths f67 of the sixth lens 60 and the seventh lens 70) are −1.799 mm, 6.282 mm, and 10.280 mm, respectively. The combined focal length f1234 of the first lens 10, the second lens 20, the third lens 30, and the fourth lens 40 is −38.797 mm. The combined focal length f567 of the fifth lens 50, the sixth lens 60, and the seventh lens 70 is 2.953 mm. The combined focal length f34567 of the third lens 30, the fourth lens 40, the fifth lens 50, the sixth lens 60, and the seventh lens 70 is 2.099 mm.

Therefore, as shown in Table 3, the wide angle lens 100 according to the present embodiment satisfies the conditional expressions (1) to (7) described in the first embodiment. First, the ratio (f34/f567) of the combined focal lengths f34 to f567 is 2.127, which satisfies the above conditional expression (1). Therefore, a chromatic aberration may be corrected in a well-balanced manner.

The ratio (f34/f0) of the combined focal length f34 to f0 is 6.947, which satisfies the above-described conditional expression (2). In this aspect, as f34/f0 exceeds 2 (the lower limit), it is possible to prevent the power of the lens disposed on the object side La from being too strong. Therefore, various aberrations such as the curvature of an image plane, a chromatic aberration of magnification, or a coma aberration, and the like, may be properly corrected, and high optical characteristics may be realized. Further, as f34/f0 is less than 9 (the upper limit), it is possible to prevent the lens diameter from being too large and to prevent the overall length of the entire lens system from being long. Therefore, the size of the wide angle lens 100 may be reduced.

The ratio (f5/f0) of the focal length f5 of the fifth lens 50 to the combined focal length f0 of the entire lens system is 3.450, which satisfies the above-described conditional expression (3). In this aspect, as f5/f0 exceeds 2 (the lower limit), it is possible to prevent the power of the lens disposed on the object side La from being too strong. Therefore, various aberrations such as the curvature of an image plane, chromatic aberration of magnification, or coma aberration may be properly corrected, and the wide angle lens 100 with desired optical characteristics may be realized. Furthermore, as f5/f0 is less than 4 (the upper limit), it is possible to prevent the lens diameter from being too large and to prevent the overall length of the entire lens system from being long. Therefore, the size of the wide angle lens 100 may be reduced.

The ratio (f567/f0) of the combined focal length f567 and f0 is 3.265, which satisfies the above-described conditional expression (4). In this aspect, as f567/f0 exceeds 2 (the lower limit), it is possible to prevent the power of the lens group including the fifth lens 50, the sixth lens 60, and the seventh lens 70 from being too strong. Therefore, correction on each aberration, particularly a chromatic aberration, may be performed in a more desired manner, and higher optical performance may be realized. Further, as f567/f0 is less than 4 (the upper limit), it is possible to prevent the lens diameter from being too large and to prevent the overall length of the entire lens system from being long. Therefore, the size of the wide angle lens may be reduced.

The absolute value (|f12/f0|) of the ratio of the combined focal length f12 to f0 is 1.989, which satisfies the above-described conditional expression (5). According to this aspect, as |f12/f0| exceeds 0.5 (the lower limit), the curvature of an image plane may be suppressed. Further, as |f12/f0| is less than 2.5 (the upper limit), the view angle may be increased.

The absolute value (|f12/f34567|) of the ratio of the combined focal length f12 to f34567 is 0.857, which satisfies the above-described conditional expression (6). In this aspect, as the value of |f12/f34567| is less than 1 (the upper limit), it is possible to prevent the positive power from being too strong. Therefore, a coma aberration and astigmatism may be properly corrected. Further, as the value of |f12/f34567| exceeds 0.1 (the lower limit), it is possible to prevent the negative power from being too strong. Therefore, it is possible to further prevent the overall length of the entire lens system from being long, and therefore it is possible to reduce the size of the wide angle lens.

The ratio (d0/f0) of the total length d0 to the combined focal length f0 is 13.517, which satisfies the above-described conditional expression (7). According to this aspect, as the value of d0/f0 exceeds 10 (the lower limit), spherical aberrations and distortion may be properly corrected. Further, as the value of d0/f0 is less than 18 (the upper limit), it is possible to prevent the lens diameter from being too large, and it is possible to prevent the overall length of the entire lens system from being long. Therefore, the size of the wide angle lens may be reduced.

As shown in FIG. 10 to FIG. 13, in the wide angle lens 100 according to the present embodiment, spherical aberrations, chromatic aberrations of magnification, astigmatism (distortions), and lateral aberrations are corrected to appropriate levels.

As described above, in the wide angle lens 100 according to the present embodiment, in the same manner as the first embodiment, the third lens 30 and the fourth lens 40 constitute the cemented lens (the first cemented lens 110). This allows high positional accuracy between the surface of the third lens 30 on the image side Lb and the surface of the fourth lens 40 on the object side La. Therefore, effects similar to those in the first embodiment may be obtained such that the curvature of an image plane and the inclination of an image plane may be sufficiently corrected.

### Other Embodiments

Although the first lens 10 is a glass lens in the above embodiment, it may be a plastic lens. In this case, the lens surface 102 of the first lens 10 on the image side Lb may be aspheric. According to the above embodiment, in order to set the positions of the third lens 30 and the fourth lens 40, the flange part 36 of the third lens 30 is provided with the protrusion section 362, and the fourth lens 40 is provided with the recess section 462; however, it is also possible to adopt a configuration in which the flange part 46 of the fourth lens 40 is provided with a protrusion section, the third lens 30 is provided with a recess section, and the inner circumferential surface (end section) of the recess section is in contact with the outer circumferential surface of the protrusion section provided on the flange part 46 of the fourth lens 40.

### INDUSTRIAL APPLICABILITY

The wide angle lens according to the present invention includes the first lens, the second lens, the third lens, the fourth lens, the aperture, the fifth lens, the sixth lens, and the seventh lens, arranged in order from the object side, and the third lens and the fourth lens constitute the cemented lens (the first cemented lens) on the object side with respect to the aperture. This allows high positional accuracy between the surface of the third lens on the image side and the surface of the fourth lens on the object side. Therefore, the curvature of an image plane and the inclination of an image plane may be sufficiently corrected. Furthermore, a chromatic aberration may be properly corrected. In addition, on the image side with respect to the aperture, there is a triplet configuration in which the fifth lens, which is a positive lens, and the cemented lens (the second cemented lens) of the sixth lens, which is a negative lens, and the seventh lens, which is a positive lens, are disposed. For this reason, astigmatism, spherical aberrations, chromatic aberrations of magnification, and the like, may be sufficiently corrected. Further, in the second cemented lens, the concave surface of the sixth lens on the image side and the convex surface of the seventh lens on the object side are joined so that aberrations other than astigmatism, e.g., chromatic aberrations, may be properly corrected. Further, a chromatic aberration of the wide angle lens may be sufficiently corrected by arranging two cemented lenses, the first cemented lens and the second cemented lens. Therefore, a higher resolution may be achieved. Furthermore, as the third lens, the fourth lens, the sixth lens, and the seventh lens are plastic lenses, cost reduction may be attained.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A wide angle lens comprises:
a first lens,
a second lens provided on an image side of the first lens,
a third lens provided on the image side of the second lens,
a fourth lens provided on the image side of the third lens,
an aperture provided on the image side of the fourth lens,
a fifth lens provided on the image side of the aperture,
a sixth lens provided on the image side of the fifth lens, and
a seventh lens provided on an image side of the sixth lens,
wherein the first lens is a negative meniscus lens having a convex surface facing the object side,
the second lens is a negative meniscus lens having a concave surface facing the image side,
the third lens is a negative lens having a concave surface facing the object side,
the fourth lens is a positive lens having a convex surface facing the image side,
the fifth lens is a positive lens,
the sixth lens is a negative lens having a concave surface facing the image side,
the seventh lens is a biconvex lens having convex surfaces facing both the object side and the image side,
each of the third lens, the fourth lens, the sixth lens, and the seventh lens is a plastic lens,
the third lens and the fourth lens constitute a first cemented lens in which a surface of the third lens on the image side and a surface of the fourth lens on the object side are joined by a resin material, and
the sixth lens and the seventh lens constitute a second cemented lens in which a surface of the sixth lens on the image side and a surface of the seventh lens on the object side are joined by a resin material.

2. The wide angle lens according to claim 1, wherein, when a combined focal length in mm of the third lens and the fourth lens is f34 and a combined focal length in mm of the fifth lens, the sixth lens, and the seventh lens is f567, the combined focal lengths f34, f567 satisfy a following condition: 1<f34/f567<4.

3. The wide angle lens according to claim 1, wherein, when a combined focal length in mm of the third lens and the fourth lens is f34 and a combined focal length in mm of an entire lens system is f0, the combined focal lengths f34, f0 satisfy a following condition: 2<f34/f0<9.

4. The wide angle lens according to claim 1, wherein, when a focal length in mm of the fifth lens is f5 and a combined focal length in mm of an entire lens system is f0, the combined focal lengths f5, f0 satisfy a following condition: 2<f5/f0<4.

5. The wide angle lens according to claim 1, wherein, when a combined focal length in mm of the fifth lens, the sixth lens, and the seventh lens is f567 and a combined focal length in mm of an entire lens system is f0 (mm), the combined focal lengths f567, f0 satisfy a following condition: 2<f567/f0<4.

6. The wide angle lens according to claim 1, wherein, when a combined focal length of the first lens and the second lens is f12 (mm) and a combined focal length of an entire lens system is f0 (mm), the combined focal lengths f12, f0 satisfy a following condition: 0.5<|f12/f0|<2.5.

7. The wide angle lens according to claim 1, wherein, when a combined focal length in mm of the first lens and the second lens is f12 and a combined focal length in mm of the third lens, the fourth lens, the fifth lens, the sixth lens, and the seventh lens is f34567, the combined focal lengths f12, f34567 satisfy a following condition: 0.1<|f12/f34567|<1.

8. The wide angle lens according to claim 1, wherein, when a total length in mm from a surface of the first lens on the object side to an image plane on an optical axis of an entire lens system is d0 and a combined focal length in mm of the entire lens system is f0, the total length d0 and the combined focal length f0 satisfy a following condition: 10<d0/f0<18.

9. The wide angle lens according to claim 1, wherein, in each of the third lens and the fourth lens, at least one of a lens surface on the object side and a lens surface on the image side is aspheric.

10. The wide angle lens according to any claim 1, wherein the fifth lens is a glass lens.

11. The wide angle lens according to claim 1, wherein the fifth lens is a biconvex lens having convex surfaces facing both the object side and the image side.

12. The wide angle lens according to claim 1, wherein
the third lens is a biconcave lens having concave surfaces facing both the object side and the image side, and
the fourth lens is a biconvex lens having convex surfaces facing both the object side and the image side.

13. The wide angle lens according to claim 1, wherein, in the first cemented lens and the second cemented lens, a magnitude relationship between refractive indices of the cemented lenses is symmetrical with respect to the aperture.

14. The wide angle lens according to claim 1, wherein, when a refractive index of the fourth lens is n4 and an Abbe number of the fourth lens is ν4, the refractive index n4 and the Abbe number ν4 respectively satisfy following conditions:
n4≥1.6
ν4≤26.

15. The wide angle lens according to claim 1, wherein, when a refractive index of the sixth lens is n6 and an Abbe number of the sixth lens is ν6, the refractive index n6 and the Abbe number ν6 respectively satisfy following conditions:
n6≥1.6
ν6≤26.

16. The wide angle lens according to claim 1, wherein, in the second lens, at least one of a lens surface on the object side and a lens surface on the image side is aspheric.

17. The wide angle lens according to claim 1, wherein the first lens is a glass lens.

18. The wide angle lens according to claim 1, wherein any one of a flange part surrounding a periphery of a lens surface of the third lens on the image side and a flange part surrounding a periphery of a lens surface of the fourth lens on the object side is provided with an end section abutting an outer circumferential surface of the other flange part and defining a position of the other flange part in a radial direction.

19. The wide angle lens according to claim 18, wherein the end section is formed in a ring shape and abuts an entire circumference of the outer circumferential surface of the other flange part.

20. The wide angle lens according to claim 1, wherein a projection system is a stereographic projection system in which a peripheral image is larger than a central image.
